(19) United States
(12) Patent Application Publication
(10) Pub. No.: US 2022/0399938 A1
(43) Pub. Date: Dec. 15, 2022

(54) OPTICAL FIBER SENSING SYSTEM, RELAY DEVICE, AND SENSING METHOD

(71) Applicant: NEC Corporation, Minato-ku, Tokyo (JP)

(72) Inventors: Yutaka YANO, Tokyo (JP); Makoto SAITOH, Tokyo (JP)

(73) Assignee: NEC Corporation, Minato-ku, Tokyo (JP)

(21) Appl. No.: 17/778,907

(22) PCT Filed: Sep. 14, 2020
(86) PCT No.: PCT/JP2020/034644

§ 371 Date: May 23, 2022

(30) Foreign Application Priority Data
Dec. 4, 2019 (JP) 2019-219922

(51) Int. Cl. H04B 10/077; G01D 5/353

(52) U.S. Cl. CPC H04B 10/0775; G01D 5/35358

(57) ABSTRACT

According to the present example embodiment, the optical fiber sensing system is an optical fiber sensing system being acquired by adding a function of optical fiber sensing to a cable of an optical communication cable system. The optical communication cable system includes the cable including an optical fiber core wire that propagates an optical signal for communication, and a plurality of devices. A function of the optical fiber sensing is a function of, by an interrogator, sending probe light to an optical fiber core wire, detecting backscattered light of the probe light, and performing sensing on environmental information around the cable. The device includes an optical wiring line through which sensing light passes without passing through an optical amplifier.

### TECHNICAL FIELD

The present invention relates to an optical fiber sensing system, a relay device, and a sensing method.

### BACKGROUND ART

There is an optical fiber sensing technique capable of detecting environmental information such as vibration and temperature in a specific position on an optical fiber by using an optical fiber as a sensor. A method called distributed acoustic sensing (DAS) in the optical fiber sensing technique detects environmental information from backscattered light of light propagating through an optical fiber.

The present sensing technique is also suitable for monitoring of a long infrastructure such as a pipeline, a railway, an expressway, and a submarine optical communication cable system. The reason is that an optical fiber itself is a sensing element, and also has two functions of a transmission medium of acquired information, and does not thus need electrical wiring and does not need consideration of electrical insulation and electromagnetic induction noise. It is not easy to cover a long distance such as a long infrastructure by arranging many dot-shaped sensor elements being constituted of an electric circuit, but it is relatively easy to cover the long distance by using an optical fiber sensing technique by installing an optical fiber along.

A sensable distance of such an optical fiber sensor technique is dominated by a loss of an optical fiber, and is typically approximately 10 km to 60 km. For example, there is Patent Literature 1 as disclosure of a technique of increasing a sensable distance by using an optical amplifier that compensates for the loss. The technique disclosed in Patent Literature 1 does not consider making a sensing function compatible with an optical fiber cable system also having a use such as communication other than sensing.

### CITATION LIST

### Patent Literature

[Patent Literature 1] U.S. Pat. No. 7,595,865

### SUMMARY OF INVENTION

### Technical Problem

An optical signal of DAS is probe light and backscattered light, and they are transmitted in opposite directions to each other in a single-core optical fiber. This is also referred to as single-core bidirectional transmission. Meanwhile, in a general wired optical communication system, bidirectional transmission is used with optical fiber two cores as a pair, and a signal can pass only in one direction through an optical amplifier used in the system. In other words, single-core bidirectional transmission is not supported in the optical amplifier.

Thus, when a sensing function by DAS is added to the general wired optical communication system, backscattered light of an optical signal of DAS is blocked by the optical amplifier, and the backscattered light from an optical fiber ahead of the optical amplifier cannot be acquired.

There is a problem that, in a cable system in which an amplification relay device for optical communication is disposed at a place closer than a sensable distance limit of DAS, DAS cannot perform sensing ahead of the amplification relay device, and, as a result, a sensable range is narrowed.

In view of the circumstances, an object of the present disclosure is to provide an optical fiber sensing system, a relay device, and a sensing method in which a sensable range is not restricted by an amplification relay device for optical communication when a sensing function is added to an optical fiber cable system also having a use such as communication other than sensing.

### Solution to Problem

An optical fiber sensing system according to one example embodiment is a cable system being acquired by adding a function of optical fiber sensing to a cable of an optical communication cable system. The optical communication cable system includes the cable including one or more cores of an optical fiber core wire configured to propagate an optical signal for communication, and a plurality of relay devices having an optical amplification function being equipped for compensating for a transmission loss of the cable. The function of the optical fiber sensing is a function of, by an interrogator, sending probe light to an optical fiber core wire in the cable, detecting backscattered light of the probe light, and performing sensing on environmental information around the cable. An optical wiring line through which the probe light and the backscattered light being light of the optical fiber sensing pass without passing through an optical amplifier in the relay device included in the optical communication cable system is provided.

A relay device according to one example embodiment is a relay device being connected to a cable including one or more cores of an optical fiber core wire configured to propagate an optical signal for communication in an optical communication cable system, and including an optical amplification function being equipped for compensating for a transmission loss of the cable. The cable includes an optical fiber sensing function of, by an interrogator, sending probe light to an optical fiber core wire in the cable, detecting backscattered light of the probe light, and performing sensing on environmental information around the cable, and the relay device includes an optical wiring line through which the probe light and the backscattered light being light of the optical fiber sensing pass without passing through an optical amplifier.

A sensing method according to one example embodiment is a sensing method in a cable system being acquired by adding a function of optical fiber sensing to a cable of an optical communication cable system including the cable including one or more cores of an optical fiber core wire configured to propagate an optical signal for communication, and a plurality of relay devices having an optical amplification function being equipped for compensating for a transmission loss of the cable. The sensing method includes: sending probe light to an optical fiber core wire in the cable; passing the probe light and the backscattered light being light of the optical fiber sensing without passing through an optical amplifier, in the relay device included in the optical communication cable system; and detecting backscattered light of the probe light, and performing sensing on environmental information around the cable.

### Advantageous Effects of Invention

According to one example embodiment, an optical fiber sensing system, a relay device, and a sensing method in which a sensable range is not restricted by an amplification relay device for optical communication when a sensing function is added to an optical fiber cable system also having a use such as communication other than sensing can be provided.

### BRIEF DESCRIPTION OF THE DRAWINGS

FIG. 1 is a configuration diagram illustrating an optical communication cable system according to a first example embodiment.

FIG. 2 is a configuration diagram illustrating the optical communication cable system according to the first example embodiment.

FIG. 3 is a cross-sectional view illustrating an amplification relay device according to a second example embodiment.

FIG. 4 is a configuration diagram illustrating an optical communication cable system according to a third example embodiment.

FIG. 5 is a graph illustrating transmission power of probe light and reception power of Rayleigh scattered light in the optical communication cable system according to the third example embodiment, and a horizontal axis indicates a distance from a terminal station and a vertical axis indicates intensity.

FIG. 6 is a configuration diagram illustrating an optical communication cable system according to a fourth example embodiment.

FIG. 7 is a cross-sectional view illustrating an amplification relay device according to a fifth example embodiment.

FIG. 8 is a configuration diagram illustrating an optical communication cable system according to a sixth example embodiment.

FIG. 9 is a configuration diagram illustrating an optical communication cable system according to a modification example of the sixth example embodiment.

FIG. 10 is a configuration diagram illustrating an optical communication cable system according to a seventh example embodiment.

FIG. 11 is a configuration diagram illustrating an optical communication cable system according to a modification example of the seventh example embodiment.

FIG. 12 is an explanatory diagram illustrating one example of a single-core bidirectional optical amplifier.

### DESCRIPTION OF EMBODIMENTS

### First Example Embodiment

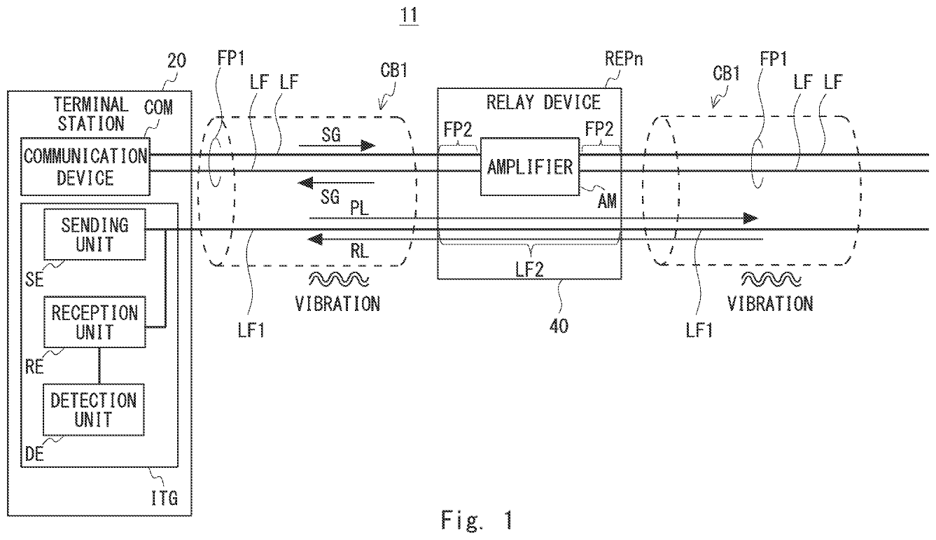

An optical fiber sensing system according to a first example embodiment will be described. First, an outline of the optical fiber sensing system according to the first example embodiment will be described. FIG. 1 is a configuration diagram illustrating an optical communication cable system according to the first example embodiment. An optical communication cable system 11 is constituted of a communication system and a measuring system.

The optical sensing system according to the present example embodiment is combined with the optical communication cable system 11, and an optical fiber core wire LF1 for sensing serving as a sensor is added to a cable CB1 including an optical fiber core wire LF for communication. In other words, the cable CB1 of the optical communication cable system 11 includes the optical fiber core wire LF for communication and the optical fiber core wire LF1 for sensing.

The optical communication cable system 11 includes the cable CB1, a terminal station 20, and a plurality of relay devices REPn. The optical sensing system includes an interrogator ITG in addition to the optical communication cable system 11.

The cable CB1 extends in one direction via the relay device REPn. For example, the plurality of relay devices REPn are provided on the cable CB1 at a predetermined interval. FIG. 1 illustrates the cable CB1 linearly, but the cable CB1 may be curved or may be laid in a U-shape.

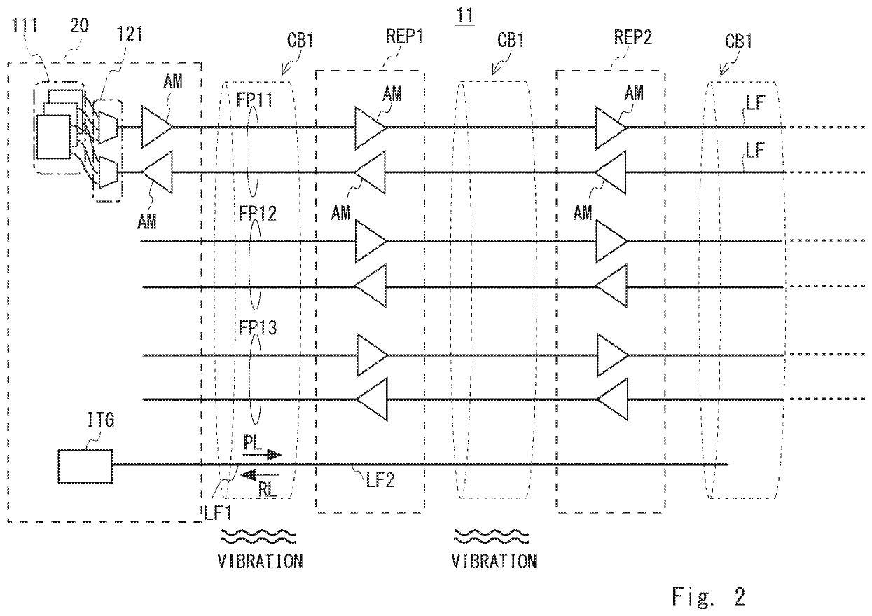

In the optical communication cable system 11, the cable CB1 includes an optical fiber pair FP1 including a pair of the optical fiber core wires LF in the cable CB1. FIG. 1 illustrates only one pair, but includes a plurality of pairs as illustrated in FIG. 2. Hereinafter, the optical fiber core wire pair is also referred to as a fiber pair (FP). Note that a fiber pair is collectively referred to as a fiber pair FP, and a specific fiber pair is referred to as a fiber pair FP1 by providing a reference sign. The same also applies to the optical fiber core wire LF, and an optical fiber core wire is collectively referred to as the optical fiber core wire LF, and a specific optical fiber core wire is referred to as the optical fiber core wire LF1 by providing a reference sign.

The fiber pair FP1 propagates an optical signal SG for communication. The fiber pair FP1 is connected to a communication device COM of the terminal station 20. The communication device COM transmits or receives the optical signal SG to or from the other terminal station 20 via the fiber pair FP1. The fiber pair FP1 is used for wavelength multiplexing communication between the terminal station 20 and a counter terminal station, which is not illustrated. In the present example embodiment, the optical fiber core wire LF1 for sensing is included in a portion of the cable CB1 including the fiber pair FP1 being connected to at least the terminal station 20 side.

The interrogator ITG is provided at the terminal station 20. The interrogator ITG sends probe light PL to the optical fiber core wire LF1 for sensing, detects backscattered light RL of the probe light PL, and performs sensing on environmental information around the optical fiber core wire LF1, i.e., around the cable CB1.

Specifically, the interrogator ITG includes a sending unit SE, a reception unit RE, and a detection unit DE. The sending unit SE sends the probe light PL to the optical fiber core wire LF1. The probe light PL is, for example, pulse light. The reception unit RE receives the backscattered light RL generated from the probe light PL. The detection unit DE detects the backscattered light RL, and performs sensing on environmental information around the optical fiber core wire LF1 for optical sensing. Then, by analyzing the detected backscattered light RL, sensing data indicating environmental information (such as vibration and temperature) at each point of the cable CB1 in a sensing range are acquired.

The relay device REPn relays the cable CB1 and the cable CB1. The relay device REPn includes a housing 40, an amplifier AM, a fiber pair FP2, and an optical fiber core wire FP2. The relay device REPn includes the amplifier AM in the housing 40. The amplifier AM is connected to the fiber pair FP1 via the fiber pair FP2. In this way, the amplifier AM amplifies and relays wavelength multiplexing communication light being transmitted from the communication device COM disposed at the terminal station 20.

On the other hand, through-connection is performed in the relay device REPn on the optical fiber core wire LF2 in the relay device REPn. The through-connection performed on the optical fiber core wire LF2 indicates that the optical fiber core wire LF2 passes through the housing 40 of the relay device REPn, whereas a part in the relay device REPn and the optical fiber core wire LF2 are not optically connected to each other. In this way, the relay device REPn includes the optical fiber core wire LF2 serving as a through wiring line.

The optical fiber core wire LF2 is connected to the optical fiber core wire LF1 for sensing in the cable CB1 at an entrance of the relay device REPn. As a result, the optical fiber core wire LF2 is a part of the optical fiber core wire LF1. Specifically, a portion of the optical fiber core wire LF1 disposed in the relay device REPn is the optical fiber core wire LF2.

Further, the fiber pair FP2 is connected to the fiber pair FP1 in the cable CB1 at an entrance of the relay device REPn. As a result, the fiber pair FP2 is a part of the fiber pair FP1. Specifically, a portion of the fiber pair FP1 disposed in the relay device REPn is the optical fiber pair FP2.

The fiber pair FP2 propagates the optical signal SG via the amplifier AM. Meanwhile, the optical fiber core wire LF2 is a through wiring line that passes the probe light PL and the backscattered light RL without the probe light PL and the backscattered light RL passing through the amplifier AM.

In optical fiber sensing, the interrogator ITG sends the probe light PL to the optical fiber core wire LF1, detects the backscattered light RL of the probe light PL, and performs sensing on environmental information around the optical fiber core wire LF1. Since the relay device REPn includes the optical fiber core wire LF2 that does not pass through the amplifier AM, a sensable range of the interrogator ITG is not restricted by the amplifier AM in the relay device REPn.

Next, the optical fiber sensing system according to the present example embodiment will be more specifically described. FIG. 2 is a configuration diagram illustrating the optical communication cable system according to the first example embodiment. As illustrated in FIG. 2, in the optical communication cable system 11, the cable CB1 includes, in the cable CB1, a plurality of fiber pairs FP11 to FP13 and the optical fiber core wire LF1 for sensing. The fiber pairs FP11 to FP13 are used for wavelength multiplexing communication between the terminal station 20 and a counter terminal station, which is not illustrated.

The terminal station 20 includes, as a main component, a plurality of wavelength demultiplexers and a plurality of transponders, but FIG. 2 only illustrates a wavelength demultiplexer 121 and a transponder group 111 that are connected to the fiber pair FP11. A wavelength demultiplexer and a transponder group that are connected to the fiber pairs FP12 to FP13 are omitted for avoiding complicatedness of drawings. Further, for a reference sign of the optical amplifier AM, the optical fiber core wire LF, and the like, the same symbol is also omitted.

In FIG. 2, the fiber pairs FP are three pairs, but may be more or less than three pairs.

In FIG. 2, the probe light PL for sensing is sent, to the optical fiber core wire LF1, from one end connected to the interrogator ITG toward another end. The backscattered light RL travels from another end side to one end side of the optical fiber core wire LF1, and is returned to the interrogator ITG. The probe light PL and the backscattered light RL are also referred to as light of optical fiber sensing.

The relay devices REPn are provided on the cable CB1 at a predetermined interval. FIG. 2 only illustrates relay devices REP1 and REP2. The relay device REPn amplifies and relays wavelength multiplexing communication light. The relay device REPn includes a plurality of the amplifiers AM. Each optical fiber core wire LF in which the optical signal SG travels in opposite directions to each other of the fiber pairs FP11 to FP13 is connected to each amplifier AM that amplifies the optical signal SG in each direction.

Next, an effect of the present example embodiment will be described. The interrogator ITG used in the optical fiber sensing system can perform sensing across the long-distance cable CB1. For example, a sensable range of the interrogator ITG is a range from the interrogator ITG to approximately 80 km. However, in the communication system, the relay device for amplifying the optical signal SG for communication is provided at an interval of a predetermined length L. Then, the predetermined length L is typically approximately 60 km. Thus, in such a general communication system, the backscattered light RL is blocked by the relay device. Therefore, sensing cannot be performed on a portion of 20 km of the cable CB1 in a subsequent stage of the relay device.

In contrast, since the through wiring line is provided in the relay device REPn in the present example embodiment, the backscattered light RL generated in the cable CB1 in a subsequent stage of the relay device REPn can be detected without being blocked by the relay device REPn. Thus, in the optical fiber sensing system according to the present example embodiment, sensing can be performed up to approximately 80 km being an upper limit of a sensing distance range of the interrogator ITG.

### Second Example Embodiment

The example described above is described with a general application example in an optical communication cable system. An application example for applying the present technique to a submarine cable system in the optical communication cable system will be described next.

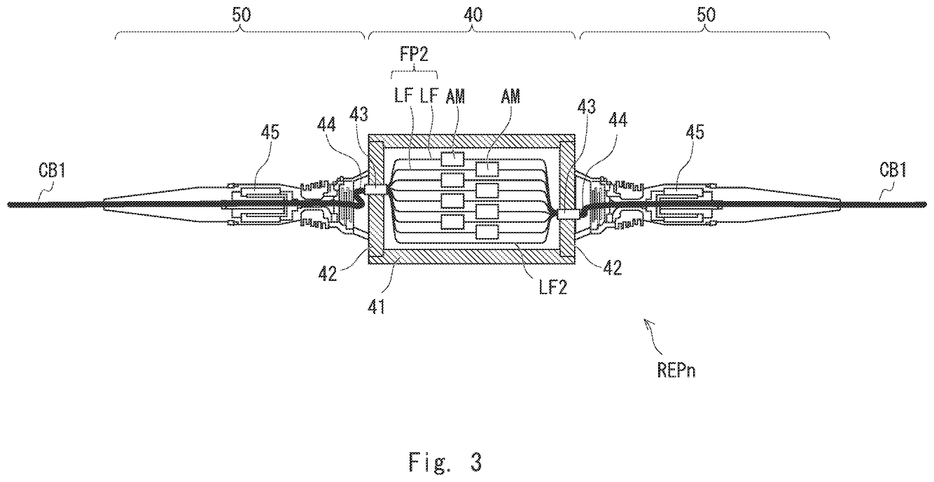

In the submarine cable system, in order to resist high water pressure and a high power supply voltage (potential difference from a ground potential), an optical fiber core wire and a power supply line in a cable are strictly protected by a pressure-resistant structure and insulation coating, and it is not easy to access them while maintaining quality. In order to access an optical fiber and a power supply line in a submarine cable, the optical fiber and the power supply line need to be guided into a housing, as illustrated in FIG. 3, having a design in sufficient consideration of water resistance and electrical insulation, and be accessed. When a submarine cable is carelessly disassembled for accessing the inside, seawater enters and comes into contact with a power supply line, and a short circuit is caused, or water enters in a longitudinal direction of the cable, and practical quality is instantly impaired.

FIG. 3 is a cross-sectional view illustrating a relay device for a submarine cable according to a second example embodiment. As illustrated in FIG. 3, a relay device REPn includes a housing 40 and a cable coupling 50. The cable coupling 50 connects an optical fiber core wire LF1 and an optical fiber core wire LF2 when a cable CB1 and the relay device REPn are connected. The housing 40 typically has a cylindrical shape, and includes, in the housing 40, a plurality of optical amplifiers AM and a plurality of optical fiber core wires LF. The housing 40 is a pressure-resistant container, and includes a cylinder 41 being a side portion, and an end plate 42 being a top plate and a bottom plate that correspond to a lid. A special part called a feedthrough 43 for passing an optical fiber and a power supply line penetrates the end plate 42. The feedthrough 43 is a part that passes an optical fiber and an electric wire while resisting a great pressure difference between both sides.

The pressure-resistant container is generally formed of a metal material, and has a ground potential since the pressure-resistant container is in contact with seawater. On the other hand, an electric part in the pressure-resistant container is sufficiently insulated from a ground potential similarly to the power supply line in the submarine cable. The insulation (resistant voltage) of equal to or more than 15 kV is generally required, and is achieved by a sufficient gap provided between an inner wall of the pressure-resistant container and an internal device. Dry air generally fills the housing.

The submarine cable is disassembled in the cable coupling 50, and a steel wire that achieves cable tensile resistance is fastened with a fastener. Further, an optical fiber and a power supply line are connected to an optical fiber cord and an electric wire (collectively referred to as a tail cable 44) in a joint chamber 45. The tail cable 44 has water resistance and voltage resistance performance equal to those of a submarine cable, but protection in terms of strength is minimum necessary protection since the protection is for a wiring material inside a device. The tail cable 44 is a part being molded and manufactured together with the feedthrough 43 provided in the end plate 42. In other words, there is no connection point from the joint chamber 45 to an entrance of the inside of the pressure-resistant housing. A minimum structure for connection while guaranteeing quality under an environment of high water pressure and a high voltage difference is the joint chamber 45.

The joint chamber 45 has a structure in which a metal frame that protects a fusion connection portion of optical fibers from water pressure and cable tension, and its whole are molded with polyethylene. An electronic part that radiates heat is not disposed in the joint chamber 45, and thus insulation can be achieved by a technique of polyethylene molding.

Each stage of manufacturing will be described. A portion inside the tail cable 44 is manufactured at a factory, and the end plate 42 is welded, sealed, and then shipped. In other words, a wiring line in the housing is fixed in the manufacturing stage, and subsequent addition of a wiring line is not possible. Next, the manufactured part is carried to a submarine cable factory, and is connected to a submarine cable via the cable coupling 50. Then, the manufactured part is loaded into a cable laying ship and is laid on a sea bottom.

When submarine cables are connected to each other on a ship, a connection part called a universal joint having a structure similar to the cable coupling 50 is used. In this way, in contrast to a cable system on the ground, it is not easy in the submarine cable system to take out a part of the optical fiber core wire LF or an electric wire being included in a cable, and a structure having a pressure-resistant structure and an insulation structure is needed.

It is a little complicated to manage such a relay device for a submarine cable by classifying the relay device into two kinds of a kind including the optical fiber core wire LF2 for passing sensing light and a kind without including the optical fiber core wire LF2, which may become a factor of an increased cost. Thus, regardless of whether to pass sensing light, a measure to set the same kind including the optical fiber core wire LF2 is suitable. When the present relay device REPn is applied to a portion through which sensing light does not pass, the core wire may not be connected to anywhere in the joint chamber 45 in the cable coupling 50.

In the present example embodiment, the relay device REPn for a submarine cable is described as an example, but the present example embodiment is not limited to the relay device REPn, and similar contrivance can be applied as long as a device has an amplification function for a communication signal.

### Third Example Embodiment

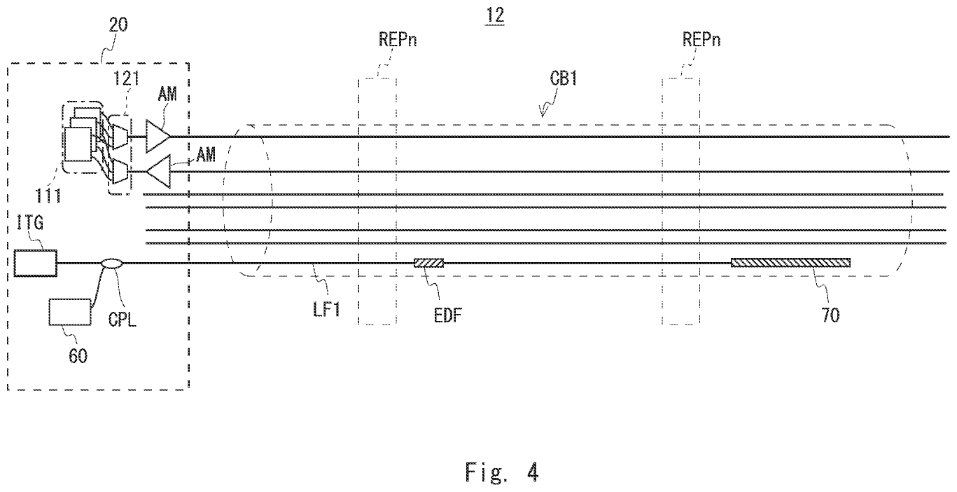

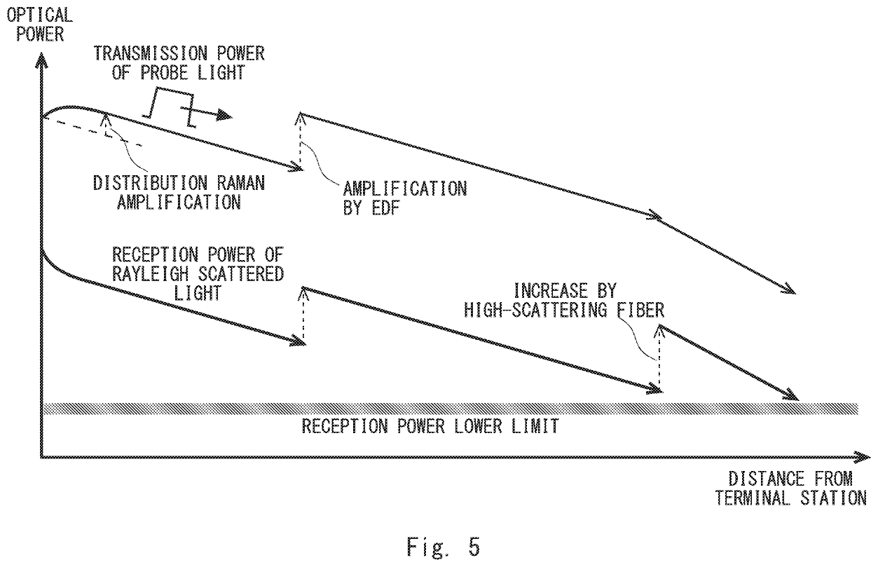

Next, an optical fiber sensing system according to a third example embodiment will be described. In the present example embodiment, a sensing distance range is increased by using a distribution Raman amplification, remote excitation EDFA, and a high-scattering fiber. FIG. 4 is a configuration diagram illustrating an optical communication cable system according to the third example embodiment. FIG. 5 is a graph illustrating transmission power of probe light and optical power of Rayleigh scattered light received by an interrogator ITG in the optical communication cable system according to the third example embodiment, and a horizontal axis indicates a distance from a terminal station and a vertical axis indicates intensity.

As illustrated in FIG. 4, in an optical communication cable system 12 according to the present example embodiment, the interrogator ITG and an excitation light source 60 at a terminal station 20 are connected, with a wavelength selection coupler CPL, to an optical fiber core wire LF1 for sensing in a cable CB1. Further, in the optical fiber core wire LF1 for sensing in the cable CB1, an erbium doped fiber EDF and a high-scattering fiber 70 are inserted into each appropriate position. For example, each of the erbium doped fiber EDF and the high-scattering fiber 70 is equipped into a section of the optical fiber core wire LF1 in which light of optical fiber sensing is attenuated.

The excitation light source 60 outputs excitation light for a distribution Raman amplification and excitation of the erbium doped fiber EDF. As a wavelength of excitation light functioning as both, a wavelength in a band of 1.47 to 1.48 μm is typically used. The erbium doped fiber EDF is an optical fiber core wire doped with erbium, and has a function of absorbing excitation light and amplifying signal light. The high-scattering fiber 70 is an optical fiber core wire LF having a great Rayleigh scattering coefficient, and, for example, includes many scattering dots of a predetermined size being provided in the optical fiber core wire LF. When probe light PL having the same power is input to a normal optical fiber and the high-scattering fiber 70, power of returned Rayleigh scattered light is remarkably greater in the high-scattering fiber 70. As one example, a fiber having a power ratio of approximately 15 dB is on the market, and an achievement example of approximately 20 dB is also reported. By applying the high-scattering fiber 70 to a section in which the probe light PL is attenuated, a sensing distance can be extended to a further step.

As illustrated in FIG. 5, a distribution Raman amplification is performed by the excitation light source 60 on the probe light PL and backscattered light RL in a position near the terminal station 20. Further, the probe light PL and the Rayleigh scattered light are also amplified by the erbium doped fiber EDF. By the optical amplifications, an arrival distance of the probe light PL extends, and a generation point of the Rayleigh scattered light that can reach the interrogator ITG at a detectable level extends farther.

Furthermore, by the probe light PL being incident on the high-scattering fiber 70, generation efficiency of the Rayleigh scattered light is increased, and thus a generation point of the Rayleigh scattered light that can reach the interrogator ITG at a detectable level extends farther.

By combining these, a sensable distance can be extended to, for example, 160 km. However, even with such contrivance being made, when a relay device for communication is present on the way, backscattered light generated in a subsequent stage of the relay device is blocked by the relay device, and sensing cannot be performed on a section ahead of the relay device.

In contrast, in the optical fiber sensing system according to the present example embodiment, a relay device REPn in which the through wiring line in the second example embodiment or the third example embodiment is incorporated is arranged at a predetermined interval along the cable CB1. (Illustration of a part for a communication signal in the relay device REPn is omitted). In this way, the interrogator ITG can detect the backscattered light RL of the probe light PL sent across a long distance without the backscattered light RL being blocked by each relay device REPn. Thus, the optical fiber sensing system according to the present example embodiment can further expand a sensing distance range, and can perform sensing on environmental information around an optical cable in a wide range.

### Fourth Example Embodiment

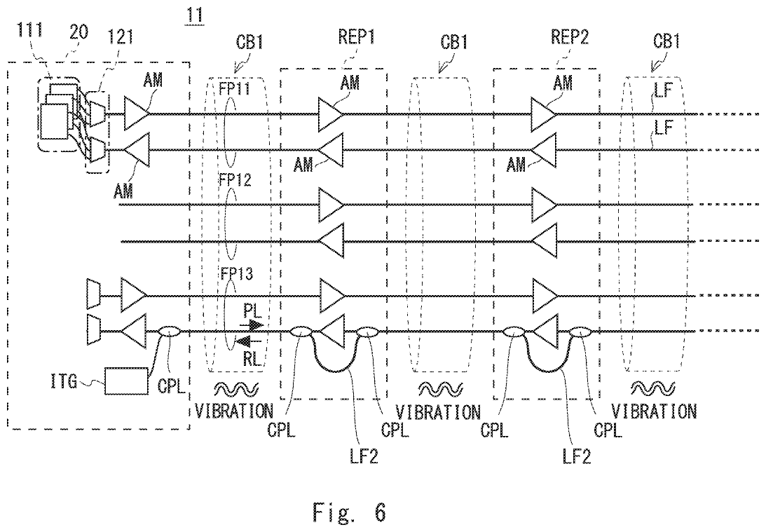

Next, an example embodiment in which a sensing-specific optical fiber core wire is not provided on a cable and wavelength multiplexing is performed on an optical fiber core wire for communication will be described. FIG. 6 is a configuration diagram illustrating an optical communication cable system according to a fourth example embodiment. Only a difference from FIG. 2 will be described, and description of the same portion will be omitted.

A difference from the configuration (FIG. 2) according to the first example embodiment is a point in that an optical fiber core wire for sensing is not provided, and an optical signal for sensing is wavelength-multiplexed and transmitted on one optical fiber core wire LF of a communication system. In the example in FIG. 6, an optical fiber core wire LF1 for optical sensing is commonly used as the optical fiber core wire LF of a fiber pair FP13 that transmits an optical signal for communication toward a terminal station 20. A wavelength band of the optical signal for communication and a wavelength of sensing light are assigned to be sufficiently away from each other in such a way as not to overlap each other.

At the terminal station 20, an input-output optical fiber of an interrogator ITG is connected, with a wavelength selection optical coupler CPL, to the optical fiber core wire LF of the fiber pair FP13 that performs transmission toward the terminal station 20. Multiplexed probe light PL is transmitted to a relay device REP1 in an opposite direction to the optical signal for communication. Further, backscattered light RL transmitted through the optical fiber core wire LF of the fiber pair FP13 that performs transmission toward the terminal station 20 has a wavelength demultiplexed by the wavelength selection optical coupler CPL, and is received by the interrogator ITG.

In the relay device REP1, the optical fiber core wire LF of the fiber pair FP13 in which sensing light is wavelength-multiplexed is connected to the wavelength selection optical coupler CPL, and an optical signal for communication and sensing light have a wavelength multiplexed and demultiplexed there. The sensing light is connected to an optical fiber core wire LF2 and propagates. Further, the optical signal for communication is connected to an optical amplifier AM and propagates.

A port on an opposite side to the relay device REP1 has a configuration having mirror symmetry with respect to the configuration described above. In other words, the optical fiber core wire LF of the fiber pair FP13 in which sensing light is wavelength-multiplexed is connected to the wavelength selection optical coupler CPL, and an optical signal for communication and sensing light have a wavelength multiplexed and demultiplexed there. The sensing light is connected to the optical fiber core wire LF2 and propagates. Further, the optical signal for communication is connected to an optical amplifier and propagates.

With this configuration, when the optical signal for communication passes through the relay device REP1, the optical signal for communication can be optically amplified by the optical amplifier, and the sensing light can detour around the amplifier and pass.

The same applies to a next relay device REP2, and the optical signal for communication can be optically amplified, and the sensing light can detour around the amplifier AM and pass. The amplification and the detour described above are repeated within a sensable distance.

Next, an effect of the present example embodiment will be described. It is clear from a comparison with the first example embodiment (FIG. 2) that a cable CB1 does not require a core wire for sensing. Thus, the present example embodiment is suitable when a sensing function is added later to an existing communication cable. An optical fiber core wire in which sensing light is wavelength-multiplexed may be determined, the wavelength selection optical coupler CPL may be provided on an input-output port of the interrogator ITG at the terminal station 20, wavelength multiplexing/demultiplexing may be performed, and the wavelength selection optical coupler CPL and the detour optical fiber core wire LF2 may be added to an entrance of one optical amplifier AM in the relay device REPn located within a sensable distance. The cable CB1 does not need to be laid again, and the optical fiber core wire LF for communication does not also need to be reduced, and a sensing function can be added.

### Fifth Example Embodiment

A fifth example embodiment is an application example for applying the present technique to a submarine cable system in an optical communication cable system.

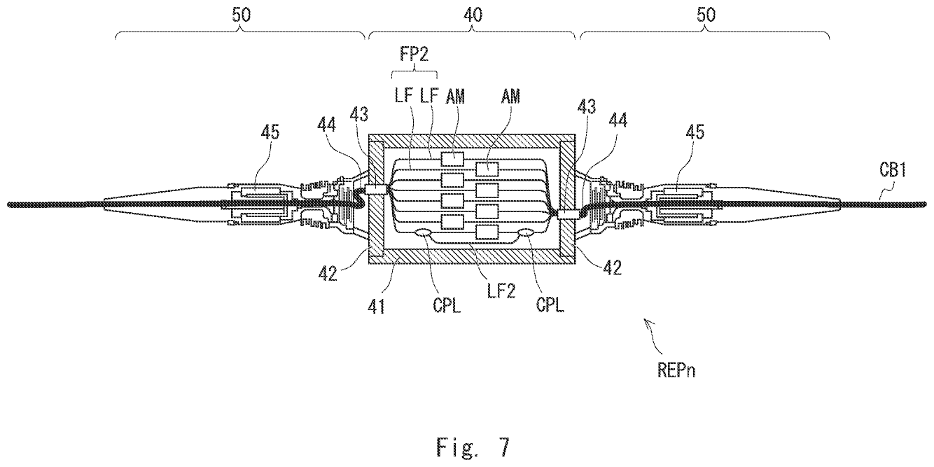

FIG. 7 is a configuration diagram illustrating the optical communication cable system according to the fifth example embodiment. Only a difference from FIG. 3 will be described, and description of the same portion will be omitted.

In FIG. 7, an optical fiber core wire LF2 is connected to a feedthrough 43 via a wavelength selection optical coupler CPL, and communicates with the outside of a housing 40. Further, the wavelength selection optical coupler CPL performs wavelength multiplexing/demultiplexing on an optical signal for communication and light of sensing.

A submarine cable CB1 and the housing 40 of a relay device REPn are connected to each other with a cable coupling 50.

It is a little complicated to manage such a relay device REPn for a submarine cable by classifying the relay device REPn into two kinds of a kind including the optical fiber core wire LF2 and the wavelength multiplexing/demultiplexing coupler CPL for passing sensing light and a kind without including the optical fiber core wire LF2 and the wavelength multiplexing/demultiplexing coupler CPL. This may become a factor of an increased cost. Thus, regardless of whether to pass sensing light, a measure to set the same kind including the optical fiber core wire LF2 and the wavelength multiplexing/demultiplexing coupler CPL is suitable. Even when the present relay device REPn is applied to a portion through which sensing light does not pass, there is no harm other than a communication signal being unable to be assigned to a wavelength assigned to the sensing light.

In the present example embodiment, the relay device REPn for a submarine cable is described as an example, but the present example embodiment is not limited to the relay device REPn, and similar contrivance can be applied as long as a device has an amplification function for a communication signal.

### Sixth Example Embodiment

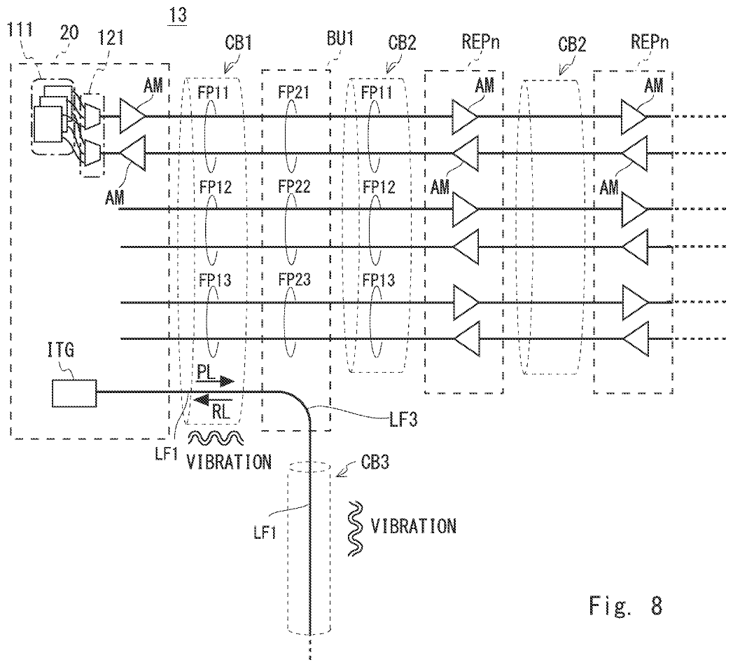

Next, an optical fiber sensing system according to a sixth example embodiment will be described. FIG. 8 is a configuration diagram illustrating an optical communication cable system according to the sixth example embodiment. As illustrated in FIG. 8, an optical communication cable system 13 according to the present example embodiment includes a branching device BU1. The branching device BU1 is disposed between a terminal station 20 and a relay device REPn or between the relay devices REPn. The branching device BU1 branches a cable CB1 into a cable CB2 and a cable CB3. Specifically, the branching device BU1 branches the cable CB1 including fiber pairs FP11 to FP13 and an optical fiber core wire LF1 into the cable CB2 including the fiber pairs FP11 to FP13 and the cable CB3 including the optical fiber core wire LF1.

The branching device BU1 is a device that does not have an optical amplification function and does not need power. Through-connection is performed on fiber pairs FP21 to FP23 for communication in the branching device BU1. In this way, in a circuit design of a communication system, the branching device BU1 hardly has an influence, and the design does not become complex.

An optical fiber core wire LF3 disposed in the branching device BU1 is connected to the optical fiber core wire LF1 in the cable CB3 for sensing. The optical fiber core wire LF3 in the present example embodiment is a through wiring line in the branching device BU1. In this way, an interrogator ITG can send probe light PL to the optical fiber core wire LF1 in the cable CB1, the optical fiber core wire LF3 in the branching device BU2, and the optical fiber core wire LF1 in the cable CB3, and receive backscattered light RL in an opposite path.

The present example embodiment provides a cable branching configuration, and its main effect is to divide a function of a cable. A communication cable is generally laid in a route having a low risk of occurrence of trouble and having stable geographical features. On the other hand, a sensing cable is not always laid in such a stable route, and may also be desired to be laid in a place having unstable geographical features depending on a monitoring target. In such a case, the present example embodiment is suitable.

Further, the present example embodiment is also suitable for a case where a communication cable is installed first, the branching device BU1 is then equipped, and a sensing cable is branched. The reason is that through-connection is performed on the optical fiber core wire LF for communication in the branching device BU1, and thus an influence on a communication system is minor. In this case, an auxiliary optical fiber core wire LF is previously provided to a cable between the interrogator ITG and the branching device BU1.

### Modification Example

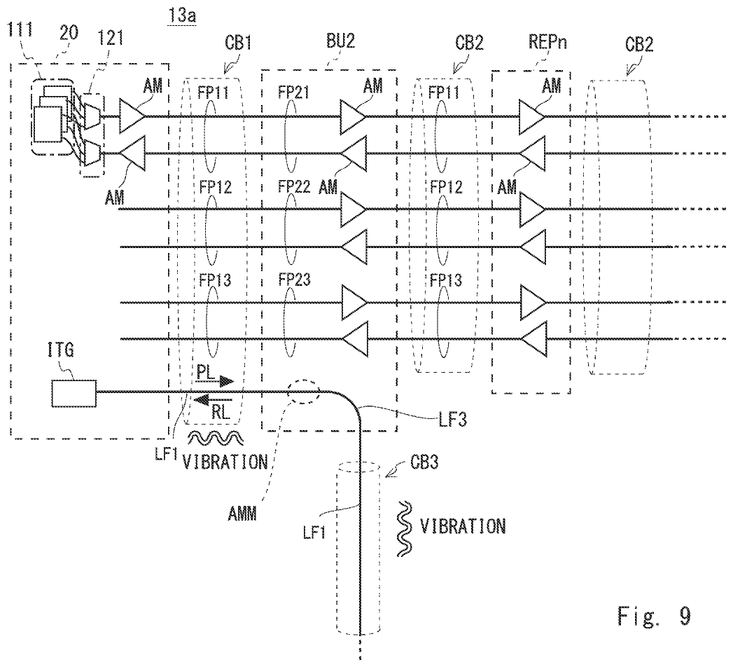

In the present example, the cable branching device BU1 having the configuration without including an optical amplifier AM, i.e., in a form without having a function of the relay device REPn is described, but those may be integrated. FIG. 9 is such a modification example. A branching device BU2 includes a plurality of amplifiers AM for communication, fiber pairs FP21 to FP23, and an optical fiber core wire LF3. Each of the amplifiers AM is connected to each of fiber pairs FP11 to FP13 in a cable CB1 via each of the fiber pairs FP21 to FP23. In this way, each of the amplifiers AM amplifies and relays wavelength multiplexing communication light being transmitted from a communication device COM disposed at a terminal station 20.

Furthermore, the branching device BU2 includes the optical amplifier AM therein, and thus includes a power source, and may further include a single-core bidirectional amplifier for the core wire LF3 for sensing. In the optical fiber core wire LF3 in the branching device BU2 in FIG. 9, a single-core bidirectional amplifier AMM is inserted into an elliptic portion indicated by a dotted line.

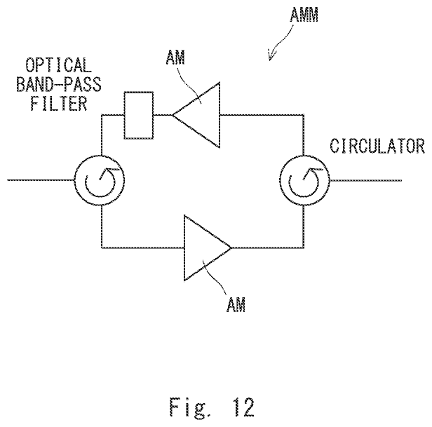

A typical achievement example of the single-core bidirectional amplifier AMM is illustrated in FIG. 12. The probe light PL and the backscattered light RL that travel in opposite directions to each other are demultiplexed by using a circulator, are each amplified by the optical amplifier AM, and are then multiplexed in single-core two directions by using the circulator again. An optical band-pass filter removes noise light generated from the optical amplifier AM in a wavelength band other than sensing light, and is inserted into an output side of the optical amplifier AM as necessary.

The amplifier AMM can amplify the probe light PL sent from the interrogator ITG, and can also amplify the backscattered light RL. Thus, a loss between the terminal station 20 and the branching device BU2 can be compensated, and sensing can be performed to a longer distance along the cable CB3.

### Seventh Example Embodiment

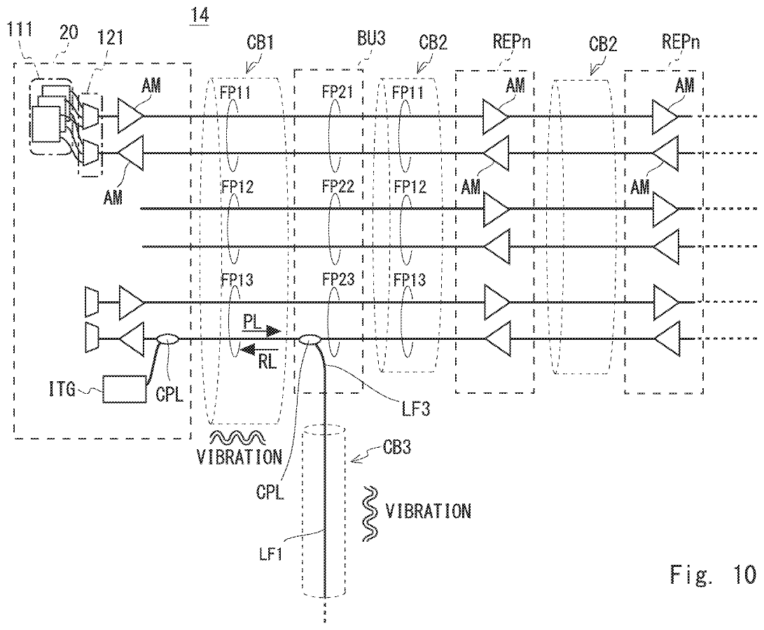

Next, an optical communication cable system according to a seventh example embodiment will be described. FIG. 10 is a configuration diagram illustrating the optical communication cable system according to the seventh example embodiment. As illustrated in FIG. 10, an optical communication cable system 14 according to the present example embodiment includes a branching device BU3. The branching device BU3 branches a cable CB1 including fiber pairs FP11 to FP13 into a cable CB2 including the fiber pairs FP11 to FP13 and a cable CB3 including an optical fiber core wire LF1.

A difference from the configuration according to the sixth example embodiment is a point in that the optical fiber core wire LF1 for sensing is not provided between an interrogator ITG and the branching device BU3, and an optical signal for sensing is wavelength-multiplexed/demultiplexed and transmitted on one optical fiber core wire LF of a communication system. In other words, the optical fiber core wire LF1 for optical sensing is commonly used as any optical fiber core wire LF of the fiber pair FP13. In FIG. 10, the optical fiber core wire LF of the fiber pair FP13 that performs transmission toward a terminal station 20 is commonly used. A wavelength band of the optical signal for communication and a wavelength of sensing light are assigned to be sufficiently away from each other in such a way as not to overlap each other.

At the terminal station 20, the input-output optical fiber core wire LF of the interrogator ITG is connected, with a wavelength selection optical coupler CPL, to the optical fiber core wire LF of the fiber pair FP13 that performs transmission toward the terminal station 20. Multiplexed probe light PL is transmitted to the branching device BU3 in an opposite direction to a communication signal. Further, backscattered light RL transmitted through the optical fiber core wire LF of the FP13 that performs transmission toward the terminal station 20 has a wavelength demultiplexed by the wavelength selection optical coupler CPL, and is received by the interrogator ITG.

In the branching device BU3, the optical fiber core wire LF3 is demultiplexed from any optical fiber core wire LF of a fiber pair FP23 via the wavelength selection optical coupler CPL. The demultiplexed optical fiber core wire LF3 is connected to the optical fiber core wire LF1 of the cable CB3. The optical fiber core wire LF3 in the present example embodiment is a through wiring line in the branching device BU3.

The branching device BU3 is a device that does not have an optical amplification function and does not need power. Through-connection is performed on fiber pairs FP21 to FP23 for communication in the branching device BU3. In this way, in a circuit design of a communication system, the branching device BU3 hardly has an influence, and the design does not become complex.

The present example embodiment also provides a cable branching configuration similarly to that described in the sixth example embodiment, and thus a main effect and an objective are to divide a function of a cable. Furthermore, there is a great advantage that the present configuration can equip the branching device BU3 and branch a sensing cable even when the optical fiber core wire LF1 for sensing is not prepared in advance in the cable CB1 between the terminal station 20 and the branching device BU3. In other words, a cable does not need to be laid again, and the optical fiber core wire LF for communication does not also need to be reduced, and a sensing function can be added.

### Modification Example

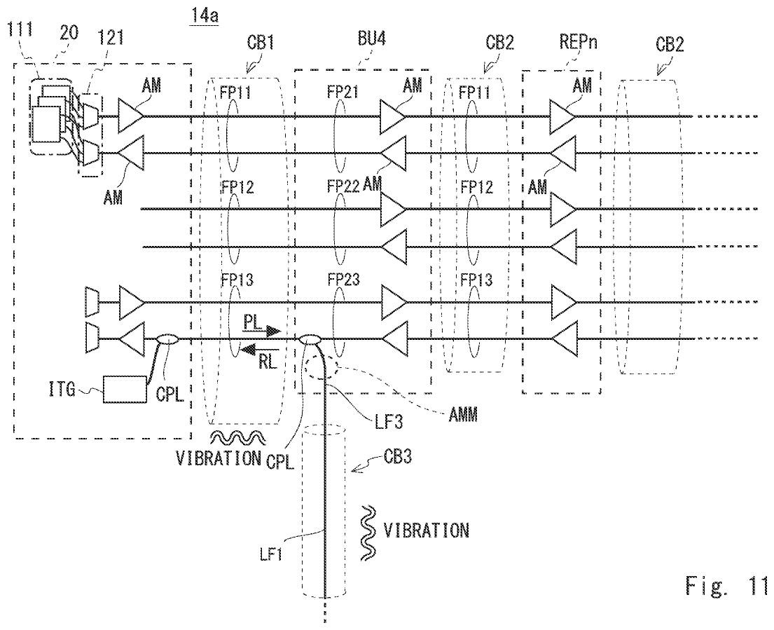

In the present example, the cable branching device BU3 having the configuration without including an optical amplifier AM, i.e., in a form without having a function of a relay device REPn is described, but those may be integrated. FIG. 11 is such a modification example. A branching device BU4 includes a plurality of amplifiers AM for communication, fiber pairs FP21 to FP23, and an optical fiber core wire LF3. Each of the amplifiers AM is connected to each of fiber pairs FP11 to FP13 in a cable CB1 via each of the fiber pairs FP21 to FP23. In this way, each of the amplifiers AM amplifies and relays wavelength multiplexing communication light being transmitted from a communication device COM disposed at a terminal station 20.

Furthermore, the branching device BU4 includes the optical amplifier AM therein, and thus includes a power source, and may further include a single-core bidirectional amplifier AMM for the core wire LF3 for sensing. In the optical fiber core wire LF3 in the branching device BU4 in FIG. 11, a single-core bidirectional amplifier AMM is inserted into an elliptic portion indicated by a dotted line.

A typical achievement example of the single-core bidirectional amplifier AMM is illustrated in FIG. 12. Description of an operation thereof will be omitted. When the amplifier AMM is added, a loss between the terminal station 20 and the branching device BU4 can be compensated, and sensing can be performed to a longer distance along the cable CB3.

In the description of the example embodiments above, the interrogator ITG is described with a network configuration installed at a terminal station of a communication system in order to facilitate understanding. However, even when the interrogator ITG is installed at a place other than the terminal station 20 in the communication system, for example, in a manner in which the interrogator ITG is incorporated into the relay device REPn or the branching devices BU1 to BU4, the contrivance of the present disclosure can be applied, and the effect can also be acquired similarly.

In the execution of the present disclosed technique, a distance of the optical fiber core wire LF1 for sensing being included in the cable CB1 used for communication needs to be at least a distance exceeding a limit of a sensable distance of the interrogator ITG, but may be greater than the distance. In other words, the relay device REPn and the cable CB1 may be manufactured in a form of always including an optical fiber core wire for sensing regardless of whether to be effectively used for sensing. In this way, kinds can be integrated, the number of auxiliary parts being prepared for a failure and the like can be reduced by half, and a cost can be reduced. However, a material cost of the additional optical fiber core wire LF is increased, and thus selection may be made by comparing with this.

Note that the present invention is not limited to the example embodiments described above, and may be appropriately modified without departing from the scope of the present invention. For example, a combination of the configurations of the first to seventh example embodiments is also included within the scope of a technical idea of the example embodiment. Further, a part or the whole of the example embodiments described above may also be described in supplementary notes below, which is not limited thereto.

### (Supplementary Note 1)

A relay device being connected to a cable including one or more cores of an optical fiber core wire configured to propagate an optical signal for communication in an optical communication cable system, being equipped for compensating for a transmission loss of the cable, and having an optical amplification function, the relay device including:

an optical fiber sensing function of, by an interrogator, sending probe light to an optical fiber core wire in the cable, detecting backscattered light of the probe light, and performing sensing on environmental information around the cable being added to the cable, and

an optical wiring line through which the probe light and the backscattered light being light of the optical fiber sensing pass without passing through an optical amplifier.

### (Supplementary Note 2)

The relay device according to Supplementary Note 1, further including:

a housing including the optical amplifier in the housing; and

a second optical fiber core wire being the optical wiring line through which light of the fiber sensing passes without passing through the optical amplifier in the housing,

wherein the first optical fiber core wire in the cable is connected to the second optical fiber core wire.

### (Supplementary Note 3)

The relay device according to Supplementary Note 2, wherein

the optical communication cable system is a submarine communication cable system,

the relay device is a device having a structure being designed in such a way as to be installed on a sea bottom,

a wiring line of a second optical fiber core wire through which light of the optical fiber sensing passes without passing through the optical amplifier in the housing is provided when the relay device is manufactured, and,

at a time of connection between the cable including the first optical fiber core wire and a relay device including the second optical fiber core wire and having the optical amplification function, the first optical fiber core wire and the second optical fiber core wire are connected to each other with a cable coupling unit.

### (Supplementary Note 4)

The relay device according to Supplementary Note 2, wherein the first optical fiber core wire in the cable includes

an optical fiber core wire section being equipped into a place where light of the optical fiber sensing is attenuated, being remotely excited, and having an optical amplification function, and

an optical fiber being equipped into a section in which light of the optical fiber sensing is attenuated, and having a great back-scattering coefficient.

### (Supplementary Note 5)

The relay device according to Supplementary Note 1, wherein

light of the optical fiber sensing and an optical signal for communication have wavelengths different from each other,

wavelength multiplexing transmission is performed on light of the optical fiber sensing in one core of an optical fiber core wire configured to propagate the optical signal for communication in the cable,

a wavelength multiplexer/demultiplexer configured to wavelength-demultiplex light of the optical fiber sensing and an optical signal for communication is provided in the housing,

light of optical fiber sensing demultiplexed by the wavelength multiplexer/demultiplexer on an input side of the optical amplifier detours around the optical amplifier and passes, and is then multiplexed by the wavelength multiplexer/demultiplexer on an output side of the optical amplifier, and

a first optical fiber core wire in the cable is connected to the optical wiring line in which light of the optical fiber sensing and an optical signal for communication in the housing are wavelength-multiplexed.

### (Supplementary Note 6)

The relay device according to Supplementary Note 5, wherein

the optical communication cable system is a submarine communication cable system,

the housing has a structure being designed in such a way as to be installed on a sea bottom,

a wavelength multiplexer/demultiplexer and a wiring line of the second optical fiber core wire for detour through which light of the optical fiber sensing passes without passing through an optical amplifier in a housing of the relay device are provided when the relay device is manufactured, and,

at a time of connection between the cable including the first optical fiber core wire, and the relay device including the wavelength multiplexer/demultiplexer and a wiring line of the second optical fiber core wire, a first optical fiber core wire for the optical fiber sensing and the second optical fiber core wire connected to the wavelength multiplexer/demultiplexer are connected to each other with a cable coupling unit.

### (Supplementary Note 7)

The relay device according to any one of Supplementary Notes 1 to 6, further including a branching device configured to branch the cable into a branching cable including a first optical fiber core wire,

wherein a through wiring line configured to pass the optical signal for communication is provided in the branching device.

### (Supplementary Note 8)

The relay device according to Supplementary Note 7, wherein

the branching device has the optical amplification function of amplifying the optical signal for communication,

the cable between the interrogator and the branching device includes the first optical fiber core wire,

the branching device includes a second optical fiber core wire through which light of the optical fiber sensing passes without passing through an optical amplifier in a housing of the branching device, and

the first optical fiber core wire in the branching cable is connected to the second optical fiber core wire in the branching device.

### (Supplementary Note 9)

The relay device according to Supplementary Note 7, wherein

light for the optical fiber sensing and an optical signal for communication have wavelengths different from each other,

in the cable between the interrogator and the branching device, wavelength multiplexing transmission is performed on light of the optical fiber sensing in one core of an optical fiber core wire configured to propagate the optical signal for communication in the cable, and

light of the optical fiber sensing being demultiplexed by the wavelength multiplexer/demultiplexer of the branching device is connected to the first optical fiber core wire in the branching cable.

### (Supplementary Note 10)

The relay device according to Supplementary Note 7, wherein

the branching device is a branching device integrated with the relay device having a function of amplifying the optical signal for communication,

light for the optical fiber sensing and an optical signal for communication have wavelengths different from each other,

in the cable between the interrogator and the branching device, wavelength multiplexing transmission is performed on light of the optical fiber sensing in one core of an optical fiber core wire configured to propagate the optical signal for communication in the cable, and

light of the optical fiber sensing being demultiplexed by the wavelength multiplexer/demultiplexer of the branching device does not pass through the optical amplifier, and is connected to the first optical fiber core wire in the branching cable.

### (Supplementary Note 11)

A sensing method in a cable system being acquired by adding a function of optical fiber sensing to a cable of an optical communication cable system, the sensing method including,

the optical communication cable system including the cable including one or more cores of optical fiber core wires configured to propagate an optical signal for communication, and a plurality of devices having an optical amplification function being equipped for compensating for a transmission loss of the cable:

sending probe light to an optical fiber core wire in the cable;

passing the probe light and the backscattered light being light of the optical fiber sensing without passing the probe light and the backscattered light through an optical amplifier in the device included in the optical communication cable system; and

detecting backscattered light of the probe light, and performing sensing on environmental information around the cable.

### (Supplementary Note 12)

The sensing method according to Supplementary Note 11, further including:

causing the cable to include a first optical fiber core wire for optical fiber sensing;

causing a device having the optical amplification function to include a second optical fiber core wire being the optical wiring line through which light of the fiber sensing passes without passing through the optical amplifier in a housing of the device; and

connecting the first optical fiber core wire in the cable to the second optical fiber core wire in a device having the optical amplification function.

### (Supplementary Note 13)

The sensing method according to Supplementary Note 12, further including,

the optical communication cable system being a submarine communication cable system, and the device being a device having a structure being designed in such a way as to be installed on a sea bottom:

providing a wiring line of a second optical fiber core wire through which light of the optical fiber sensing passes without passing through an optical amplifier in a housing of the device when a device having the optical amplification function is manufactured; and,

at a time of connection between the cable including the first optical fiber core wire and a device including the second optical fiber core wire and having the optical amplification function,

connecting the first optical fiber core wire and the second optical fiber core wire to each other with a cable coupling unit.

### (Supplementary Note 14)

The sensing method according to Supplementary Note 12, further including: causing the first optical fiber core wire in the cable to include

an optical fiber core wire section being equipped into a place where light of the optical fiber sensing is attenuated, being remotely excited, and having an optical amplification function, and

an optical fiber being equipped into a section in which light of the optical fiber sensing is attenuated, and having a great back-scattering coefficient.

### (Supplementary Note 15)

The sensing method according to Supplementary Note 11, further including:

setting light of the optical fiber sensing and an optical signal for communication to have wavelengths different from each other;

performing wavelength multiplexing transmission on light of the optical fiber sensing in one core of an optical fiber core wire configured to propagate the optical signal for communication in the cable;

causing the device to include a wavelength multiplexer/demultiplexer configured to wavelength-demultiplex light of the optical fiber sensing and an optical signal for communication;

causing light of optical fiber sensing demultiplexed by the wavelength multiplexer/demultiplexer on an input side of the optical amplifier to detour around the optical amplifier and pass, and then be multiplexed by the wavelength multiplexer/demultiplexer on an output side of the optical amplifier; and

connecting a first optical fiber core wire in the cable to the optical wiring line in which light of the optical fiber sensing and an optical signal for communication in the device are wavelength-multiplexed.

### (Supplementary Note 16)

The sensing method according to Supplementary Note 15, further including:

setting the optical communication cable system to be a submarine communication cable system, and the device to be a device having a structure being designed in such a way as to be installed on a sea bottom;

providing, when the device is manufactured, a wavelength multiplexer/demultiplexer and a wiring line of the second optical fiber core wire for detour through which light of the optical fiber sensing passes without passing through an optical amplifier in a housing of the device; and,

at a time of connection between the cable including the first optical fiber core wire, and the device including the wavelength multiplexer/demultiplexer and a wiring line of the second optical fiber core wire,

connecting, to each other with a cable coupling unit, a first optical fiber core wire for the optical fiber sensing and the second optical fiber core wire connected to the wavelength multiplexer/demultiplexer.

### (Supplementary Note 17)

The sensing method according to any one of Supplementary Notes 11 to 16 in a cable system being acquired by adding a function of optical fiber sensing to a cable of the optical communication cable system, the sensing method further including:

providing a branching device configured to branch the cable into a branching cable including the first optical fiber core wire; and

providing, in the branching device, a through wiring line configured to pass the optical signal for communication.

### (Supplementary Note 18)

The sensing method according to Supplementary Note 17, further including:

setting the branching device to be a branching device integrated with a device having the optical amplification function of amplifying the optical signal for communication;

causing the cable between the interrogator and the branching device to include the first optical fiber core wire;

causing the branching device to include a second optical fiber core wire through which light of the optical fiber sensing passes without passing through an optical amplifier in a housing of the branching device; and

connecting the first optical fiber core wire in the branching cable to the second optical fiber core wire in the integrated branching device.

### (Supplementary Note 19)

The sensing method according to Supplementary Note 17, further including:

setting light for the optical fiber sensing and an optical signal for communication to have wavelengths different from each other;

performing, in the cable between the interrogator and the branching device, wavelength multiplexing transmission on light of the optical fiber sensing in one core of an optical fiber core wire configured to propagate the optical signal for communication in the cable; and

connecting, to the first optical fiber core wire in the branching cable, light of the optical fiber sensing being demultiplexed by the wavelength multiplexer/demultiplexer of the branching device.

### (Supplementary Note 20)

The sensing method according to Supplementary Note 17, further including:

setting the branching device to be a branching device integrated with a device having the optical amplification function of amplifying the optical signal for communication;

setting light for the optical fiber sensing and an optical signal for communication to have wavelengths different from each other;

performing, in the cable between the interrogator and the branching device, wavelength multiplexing transmission on light of the optical fiber sensing in one core of an optical fiber core wire configured to propagate the optical signal for communication in the cable; and

setting light of the optical fiber sensing being demultiplexed by a wavelength multiplexer/demultiplexer of the branching device not to pass through the optical amplifier, and connecting light of the optical fiber sensing to the first optical fiber core wire in the branching cable.

Although the invention of the present application has been described with reference to the example embodiments, the invention of the present application is not limited to the above-described example embodiments. Various modifications that can be understood by those skilled in the art can be made to the configuration and the details of the invention of the present application within the scope of the invention.

This application is based upon and claims the benefit of priority from Japanese patent application No. 2019-219922, filed on Dec. 4, 2019, the disclosure of which is incorporated herein in its entirety by reference.

### REFERENCE SIGNS LIST

11, 12, 13, 13a, 14, 14a Cable system
20 Terminal station
40 Housing
43 Feedthrough
44 Tail cable
45 Joint chamber
50 Cable coupling
60 Excitation light source
70 High-scattering fiber
111 Transponder group
121 Wavelength demultiplexer
AM Amplifier
BU1, BU2, BU3, BU4 Branching device
CB1, CB2, CB3 Cable
COM Communication device
CPL Coupler
DE Detection unit
EDF Erbium doped fiber
FP1, FP2, FP11, FP12, FP13, FP21, FP22, FP23 Fiber pair
ITG Interrogator
LF, LF1, LF2, LF3 Optical fiber core wire
PL Probe light
RE Reception unit
REPn, REP1, REP2 Relay device
RL Backscattered light
SE Sending unit
SG Optical signal

What is claimed is:

1. An optical fiber sensing system in a cable system being acquired by adding a function of optical fiber sensing to a cable of an optical communication cable system, the optical fiber sensing system comprising:
the optical communication cable system including the cable including one or more cores of an optical fiber core wire configured to propagate an optical signal for communication, and a plurality of devices having an optical amplification function being equipped for compensating for a transmission loss of the cable;
a function of the optical fiber sensing being a function of, by an interrogator, sending probe light to an optical fiber core wire in the cable, detecting backscattered light of the probe light, and performing sensing on environmental information around the cable; and
an optical wiring line through which the probe light and the backscattered light being light of the optical fiber sensing pass without passing through an optical amplifier, in the device included in the optical communication cable system.

2. The optical fiber sensing system according to claim 1, wherein
the cable includes a first optical fiber core wire for optical fiber sensing,
a device having the optical amplification function includes a second optical fiber core wire being the optical wiring line through which light of the optical fiber sensing passes without passing through the optical amplifier in a housing of the device, and
the first optical fiber core wire in the cable is connected to the second optical fiber core wire in a device having the optical amplification function.

3. The optical fiber sensing system according to claim 2, wherein
the optical communication cable system is a submarine communication cable system, and the device is a device having a structure being designed in such a way as to be installed on a sea bottom,
a wiring line of a second optical fiber core wire through which light of the optical fiber sensing passes without passing through an optical amplifier in a housing of the device is provided when a device having the optical amplification function is manufactured, and,
at a time of connection between the cable including the first optical fiber core wire and a device including the second optical fiber core wire and having the optical amplification function, the first optical fiber core wire and the second optical fiber core wire are connected to each other with a cable coupling unit.

4. The optical fiber sensing system according to claim 2, wherein the first optical fiber core wire in the cable includes
an optical fiber core wire section being equipped into a place in which light of the optical fiber sensing is attenuated, being remotely excited, and having an optical amplification function, and
an optical fiber being equipped into a section in which light of the optical fiber sensing is attenuated, and having a great back-scattering coefficient.

5. The optical fiber sensing system according to claim 1, wherein
light of the optical fiber sensing and an optical signal for communication have wavelengths different from each other,
wavelength multiplexing transmission is performed on light of the optical fiber sensing in one core of an optical fiber core wire configured to propagate the optical signal for communication in the cable,
the device includes a wavelength multiplexer/demultiplexer configured to wavelength-demultiplex light of the optical fiber sensing and an optical signal for communication,
light of optical fiber sensing demultiplexed by the wavelength multiplexer/demultiplexer on an input side of the optical amplifier detours around the optical amplifier and passes, and is then multiplexed by the wavelength multiplexer/demultiplexer on an output side of the optical amplifier, and
a first optical fiber core wire in the cable is connected to the optical wiring line in which light of the optical fiber sensing and an optical signal for communication in the device are wavelength-multiplexed.

6. The optical fiber sensing system according to claim 5, wherein
the optical communication cable system is a submarine communication cable system, and the device is a device having a structure being designed in such a way as to be installed on a sea bottom,
a wavelength multiplexer/demultiplexer and a wiring line of a second optical fiber core wire for detour through which light of the optical fiber sensing passes without passing through an optical amplifier in a housing of the device are provided when the device is manufactured, and,
at a time of connection between the cable including the first optical fiber core wire, and the device including the wavelength multiplexer/demultiplexer and a wiring line of the second optical fiber core wire for detour, a first optical fiber core wire for the optical fiber sensing and the second optical fiber core wire connected to the wavelength multiplexer/demultiplexer are connected to each other with a cable coupling unit.

7. The optical fiber sensing system according to claim 1, being a cable system being acquired by adding a function of optical fiber sensing to a cable of the optical communication cable system, the optical fiber sensing system further comprising a branching device configured to branch the cable into a branching cable including a first optical fiber core wire,
wherein a through wiring line configured to pass the optical signal for communication is provided in the branching device.

8. The optical fiber sensing system according to claim 7, wherein
the branching device is a branching device integrated with a device having the optical amplification function of amplifying the optical signal for communication,
the cable between the interrogator and the branching device includes the first optical fiber core wire,
the branching device includes a second optical fiber core wire through which light of the optical fiber sensing passes without passing through an optical amplifier in a housing of the branching device, and
the first optical fiber core wire in the branching cable is connected to the second optical fiber core wire in the branching device.

9. The optical fiber sensing system according to claim 7, wherein
light for the optical fiber sensing and an optical signal for communication have wavelengths different from each other,
in the cable between the interrogator and the branching device, wavelength multiplexing transmission is performed on light of the optical fiber sensing in one core of an optical fiber core wire configured to propagate the optical signal for communication in the cable, and
light of the optical fiber sensing being demultiplexed by a wavelength multiplexer/demultiplexer of the branching device is connected to the first optical fiber core wire in the branching cable.

10. The optical fiber sensing system according to claim 7, wherein
the branching device is a branching device integrated with a device having the optical amplification function of amplifying the optical signal for communication,
light for the optical fiber sensing and an optical signal for communication have wavelengths different from each other,
in the cable between the interrogator and the branching device, wavelength multiplexing transmission is performed on light of the optical fiber sensing in one core of an optical fiber core wire configured to propagate the optical signal for communication in the cable, and
light of the optical fiber sensing being demultiplexed by a wavelength multiplexer/demultiplexer of the branching device does not pass through the optical amplifier, and is connected to the first optical fiber core wire in the branching cable.

11. A relay device being connected to a cable including one or more cores of an optical fiber core wire configured to propagate an optical signal for communication in an optical communication cable system, and having an optical amplification function being equipped for compensating for a transmission loss of the cable, the relay device comprising:
an optical fiber sensing function of, by an interrogator, sending probe light to an optical fiber core wire in the cable, detecting backscattered light of the probe light, and performing sensing on environmental information around the cable, being added to the cable; and
an optical wiring line through which the probe light and the backscattered light being light of the optical fiber sensing pass without passing through an optical amplifier.

12. The relay device according to claim 11, further comprising:
a housing including the optical amplifier in the housing; and
a second optical fiber core wire being the optical wiring line through which light of the optical fiber sensing passes without passing through the optical amplifier in the housing,
wherein the first optical fiber core wire in the cable is connected to the second optical fiber core wire.

13. The relay device according to claim 12, wherein
the optical communication cable system is a submarine communication cable system,
the relay device is a device having a structure being designed in such a way as to be installed on a sea bottom,
a wiring line of a second optical fiber core wire through which light of the optical fiber sensing passes without passing through the optical amplifier in the housing is provided when the relay device is manufactured, and,
at a time of connection between the cable including the first optical fiber core wire and a relay device including the second optical fiber core wire and having the optical amplification function, the first optical fiber core wire and the second optical fiber core wire are connected to each other with a cable coupling unit.

14. The relay device according to claim 12, wherein the first optical fiber core wire in the cable includes
an optical fiber core wire section being equipped into a place in which light of the optical fiber sensing is attenuated, being remotely excited, and having an optical amplification function, and
an optical fiber being equipped into a section in which light of the optical fiber sensing is attenuated, and having a great back-scattering coefficient.

15. The relay device according to claim 12, wherein
light of the optical fiber sensing and an optical signal for communication have wavelengths different from each other,
wavelength multiplexing transmission is performed on light of the optical fiber sensing in one core of an optical fiber core wire configured to propagate the optical signal for communication in the cable,
a wavelength multiplexer/demultiplexer configured to wavelength-demultiplex light of the optical fiber sensing and an optical signal for communication is provided in the housing,
light of optical fiber sensing demultiplexed by the wavelength multiplexer/demultiplexer on an input side of the optical amplifier detours around the optical amplifier and passes, and is then multiplexed by the wavelength multiplexer/demultiplexer on an output side of the optical amplifier, and
a first optical fiber core wire in the cable is connected to the optical wiring line in which light of the optical fiber sensing and an optical signal for communication in the housing are wavelength-multiplexed.

16. A sensing method in a cable system being acquired by adding a function of optical fiber sensing to a cable of an optical communication cable system, the sensing method comprising,
the optical communication cable system including the cable including one or more cores of an optical fiber core wire configured to propagate an optical signal for communication, and a plurality of devices having an optical amplification function being equipped for compensating for a transmission loss of the cable:
sending probe light to an optical fiber core wire in the cable;
passing the probe light and backscattered light being light of the optical fiber sensing without passing through an optical amplifier in the device included in the optical communication cable system; and
detecting the backscattered light of the probe light, and performing sensing on environmental information around the cable.

17. The sensing method according to claim 16, further comprising:
causing the cable to include a first optical fiber core wire for optical fiber sensing;
causing a device having the optical amplification function to include a second optical fiber core wire being the optical wiring line through which light of the optical fiber sensing passes without passing through the optical amplifier in a housing of the device; and
connecting the first optical fiber core wire in the cable to the second optical fiber core wire in a device having the optical amplification function.

18. The sensing method according to claim 17, further comprising,
the optical communication cable system being a submarine communication cable system, the device being a device having a structure being designed in such a way as to be installed on a sea bottom:
providing a wiring line of a second optical fiber core wire through which light of the optical fiber sensing passes without passing through an optical amplifier in a housing of the device when a device having the optical amplification function is manufactured; and,
at a time of connection between the cable including the first optical fiber core wire and a device including the second optical fiber core wire and having the optical amplification function,
connecting the first optical fiber core wire and the second optical fiber core wire to each other with a cable coupling unit.

19. The sensing method according to claim 17, further comprising causing the first optical fiber core wire in the cable to include
an optical fiber core wire section being equipped into a place in which light of the optical fiber sensing is attenuated, being remotely excited, and having an optical amplification function, and
an optical fiber being equipped into a section in which light of the optical fiber sensing is attenuated, and having a great back-scattering coefficient.

20. The sensing method according to claim 17, further comprising:
setting light of the optical fiber sensing and an optical signal for communication to have wavelengths different from each other;
performing wavelength multiplexing transmission on light of the optical fiber sensing in one core of an optical fiber core wire configured to propagate the optical signal for communication in the cable;
causing the device to include a wavelength multiplexer/demultiplexer configured to wavelength-demultiplex light of the optical fiber sensing and an optical signal for communication;
causing light of optical fiber sensing demultiplexed by the wavelength multiplexer/demultiplexer on an input side of the optical amplifier to detour around the optical amplifier and pass, and then be multiplexed by the wavelength multiplexer/demultiplexer on an output side of the optical amplifier; and
connecting a first optical fiber core wire in the cable to the optical wiring line in which light of the optical fiber sensing and an optical signal for communication in the device are wavelength-multiplexed.
